(19) United States
(12) Patent Application Publication
(10) Pub. No.: US 2025/0245949 A1
(43) Pub. Date: Jul. 31, 2025

(54) METHOD FOR GENERATING VIRTUAL AVATAR, ELECTRONIC DEVICE, AND STORAGE MEDIUM

(71) Applicant: Beijing Zitiao Network Technology Co., Ltd., Beijing (CN)

(72) Inventors: Xiaozheng ZHENG, Beijing (CN); Chao WEN, Beijing (CN)

(21) Appl. No.: 19/038,018

(22) Filed: Jan. 27, 2025

(30) Foreign Application Priority Data
Jan. 26, 2024 (CN) 202410114774.0

(51) Int. Cl. G06T 19/20; G06T 15/04; G06T 15/60

(52) U.S. Cl. CPC G06T 19/20; G06T 15/04; G06T 15/60; G06T 2210/56; G06T 2219/004; G06T 2219/2012

(57) ABSTRACT

The present disclosure provides a method for generating a virtual avatar, an apparatus, an electronic device, and a storage medium. The method for generating a virtual avatar includes: training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and inputting a single second image of a second object and a second label corresponding to the second image into the first algorithm model trained such that the first algorithm model generates a second avatar of the second object according to the first avatar.

### CROSS-REFERENCE TO RELATED APPLICATION

This application claims the priority to and benefits of the Chinese Patent Application, No. 202410114774.0, which was filed on Jan. 26, 2024. The aforementioned patent application is hereby incorporated by reference in its entirety.

### TECHNICAL FIELD

The present disclosure relates to the technical field of computers, and more particularly to a method for generating a virtual avatar, an apparatus, an electronic device, and a storage medium.

### BACKGROUND

Neural network image algorithms widely adopt data-driven deep learning methods, and can be used in terminals such as virtual reality devices for, for example, gesture recognition, gesture control, etc. and can also be used to generate new images on the basis of existing images.

### SUMMARY

The present disclosure provides a method for generating a virtual avatar, an apparatus, an electronic device, and a storage medium.

The present disclosure adopts the following technical solution.

In some embodiments, the present disclosure provides a method for generating a virtual avatar, including:
training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
inputting a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.

In some embodiments, the present disclosure provides an apparatus for generating a virtual avatar, including:
a training unit configured for training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
a generation unit configured for inputting a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.

In some embodiments, the present disclosure provides an electronic device, including:
at least one memory and at least one processor,
wherein the at least one memory is configured for storing program codes, and the at least one processor is configured for calling the program codes stored in the at least one memory to perform the above described method.

In some embodiments, the present disclosure provides a computer-readable storage medium, configured for storing program codes, wherein the program codes, when executed by a processor, cause the processor to perform the above described method.

An embodiment of the present disclosure provides for generating a drivable implicit second avatar using only a single second image, which, on the basis of the properties of the implicit expression, can achieve high fidelity and reduce data volume requirements.

### BRIEF DESCRIPTION OF DRAWINGS

The foregoing contents and other features, advantages, and aspects of embodiments of the present disclosure will become more apparent with reference to the following detailed description when taken in conjunction with the accompanying drawings. Throughout the drawings, the same or similar reference numerals indicate the same or similar elements. It should be understood that the drawings are schematic and that components and elements are not necessarily drawn to scale.

FIG. 1 is a flowchart of a method for generating a virtual avatar according to an embodiment of the present disclosure.

FIG. 2 is a schematic diagram of a method for generating a virtual avatar according to an embodiment of the present disclosure.

FIG. 3 is a schematic diagram of a method for generating a virtual avatar according to an embodiment of the present disclosure.

FIG. 4 is a schematic diagram of a first algorithm model according to an embodiment of the present disclosure.

FIG. 5 is a schematic diagram of a method for generating a virtual avatar according to an embodiment of the present disclosure.

FIG. 6 is a schematic diagram of generating three-dimensional shadow information according to an embodiment of the present disclosure.

FIG. 7 is a schematic diagram of a method for generating a virtual avatar according to an embodiment of the present disclosure.

FIG. 8 is a schematic diagram of an electronic device according to an embodiment of the present disclosure.

### DETAILED DESCRIPTION

It is to be understood that prior to using the technical solutions disclosed in the various embodiments of the present disclosure, a user should be informed of the type, scope of use, use scenario, etc. of personal information involved in the present disclosure and be authorized by the user in an appropriate manner according to relevant laws and regulations.

For example, in response to receiving a user's active request, prompt information is sent to the user to explicitly prompt the user that the operations they request to perform will require obtaining and using the user's personal information. Accordingly, a user can autonomously select whether to provide personal information to software or hardware, such as an electronic device, an application program, a server or a storage medium, which performs the operations of the technical solution of the present disclosure, according to the prompt information.

As an alternative but non-limiting implementation, in response to receiving the user's active request, the manner in which the alert information is sent to the user may be, for example, in the form of a pop-up window in which the alert information may be presented in text. In addition, the pop-up window may also carry a selection control for the user to select “agree” or “disagree” to provide personal information to the electronic device.

It is to be understood that the above-described notification and acquisition of user authorization processes are merely illustrative and do not limit implementations of the present disclosure, and that other ways of satisfying relevant laws and regulations may be applied to implementations of the present disclosure.

It is understood that the data involved in this technical solution (including but not limited to the data itself, the acquisition or use of the data) shall comply with the requirements of corresponding laws and regulations and relevant provisions.

Embodiments of the present disclosure will be described in more details below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that various steps described in the method embodiments of the present disclosure can be performed in parallel and/or in parallel. Furthermore, method embodiments may include additional steps and/or omit performing the illustrated steps. The scope of the present disclosure is not limited in this respect.

As used herein, the term “include” and its variants are open-ended including, that is, “include but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following description.

It should be noted that the concepts of “first” and “second” mentioned in this disclosure are only used to distinguish different devices, modules or units, and are not used to limit the order or interdependence of the functions performed by these devices, modules or units.

It should be noted that the modification of “a” mentioned in this disclosure is schematic rather than limiting, and those skilled in the art should understand that it should be understood as “one or more” unless the context clearly indicates otherwise.

The names of messages or information that interact between apparatuses in embodiments of the present disclosure are for illustrative purposes only and are not intended to limit the scope of such messages or information.

Hereinafter, the solutions provided in the embodiments of the present disclosure will be described in detail with reference to the accompanying drawings.

### Explanation of Terms:

Avatar: a textured drivable three-dimensional model, such as a digitized drivable three-dimensional model of a hand avatar that is a hand representation of a person. In order to achieve true digitization, it is necessary to ensure the high sense of reality of the avatar.

Drivable: the pose of the avatar can be controlled using predefined pose parameters.

High reality: the quality of the rendered image is close to a real scene picture taken by a hardware device such as a camera.

Rendering: the process of generating a two-dimensional image through a program for a three-dimensional scene.

Neural rendering algorithm: by setting the camera position and using neural network, the algorithm of rendering with high sense of reality is realized.

Volume rendering: methods of generating 2D projections from discrete 3D sampling points in computer graphics and scientific visualization.

Hand parameterization model: a three-dimensional network model binding a set of parameters that can control the shape of the model by changing the values of the parameters.

MANO: a parameterized network model relating to a hand, including a parameter for controlling a shape and a parameter for controlling a pose.

LPIPS loss function: a perceptual loss function, intended to capture perceptual differences between images, such as content and style differences, that are not always apparent at the pixel level, using a convolutional neural network.

In the related art, a method based on display modeling or based on implicit modeling is generally employed.

Taking creating a hand avatar as an example, in the method based on display modeling, a hand mesh structure and a corresponding texture map are obtained by reconstruction, and then the hand avatar is generated. In the method of using display modeling, if the hand avatar of a certain target person is reconstructed on the basis of a single hand map of the target person, the effect is poor because less data cannot generate a hand avatar with a high sense of reality.

In the method based on implicit modeling, the implicit neural geometric identification and texture representation of the hand are learned from the data via the neural network, and the complete hand avatar is obtained by dense sampling. Implicit modeling has a good effect on the fidelity of the hand avatar, but when the hand avatar of a certain target person is reconstructed, it needs a large number of multi-view images or time series data of the target person to generate the hand avatar, and the effect of using only a single image of the target person's hand is poor. It can be seen that the method based on implicit modeling in the related art requires a large amount of data, and the effect of generating the avatar on the basis of a single image is poor.

In some embodiments of the present disclosure, a method for generating a virtual avatar is proposed, which is a method based on implicit modeling of a single image and takes into account high sense of reality and drivable properties.

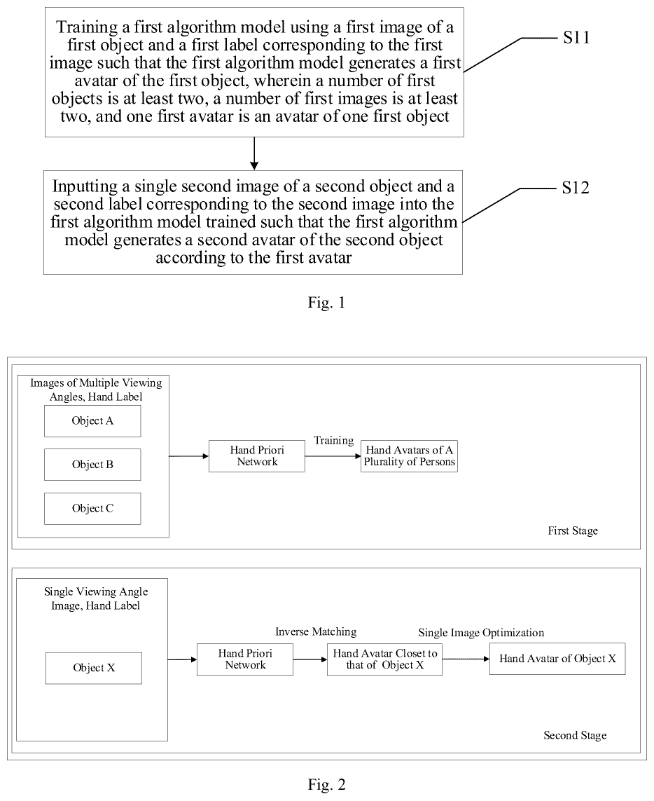

As shown in FIG. 1, which is a flowchart of a method for generating a virtual avatar according to an embodiment of the present disclosure, the method includes the following steps.

Step S11, training a first algorithm model using a first image of a first object and a first label corresponding to the first image such that the first algorithm model generates a first avatar of the first object, wherein a number of first objects is at least two, a number of first images is at least two, and one first avatar is an avatar of one first object.

In some embodiments, the method proposed by the present disclosure may be used in a terminal, for example in an extended reality device for such as virtual reality, mixed reality or augmented reality. The first object may, for example, be a limb of a human body, for example a hand of a human body. A number of first objects is at least two, e.g. three, four, five or more, and different first objects may, for example, be hands of different persons. A number of first images is at least two, one first image has one first object therein, one first object may correspond to multiple first images, and the multiple first images may include images of the first object taken under different viewing angles. For example, the first object may be hands of different persons, and for each hand, a plurality of images of the hand are taken at different viewing angles. The first label is a label previously set for the first image, and the first label can be obtained by manually labelling or automatically labelling the first image, wherein the first image and the first label are used for training the first algorithm model, an input of the first algorithm model can include an image and a label, and an output of the first algorithm model can include an avatar corresponding to the input image and the label. A label may include, for example, an object mesh and an object pose of an object in its corresponding image, and the object mesh may be an appearance mesh shape of the object characterized by a mesh form. The first algorithm model may be a neural network algorithmic model. The first avatar is in a one-to-one relationship with the first object, with one first avatar being an avatar of one first object, for example, one first avatar being one hand of one particular person.

Step S12, inputting a single second image of a second object and a second label corresponding to the second image into the first algorithm model trained such that the first algorithm model generates a second avatar of the second object according to the first avatar.

In some embodiments, the second image input to the first algorithm model has only one image, which is an image of a second object in which the second object is displayed, a number of the second object is one, a second avatar is an avatar of the second object, and the second object is a homogeneous object different from the first object. For example, the second object may also be a limb of a human body, in particular a hand of a human body, and the first objects and the second object may be the same limb of the human body, but are limbs of different persons, namely, each of the first objects and the second object may be the hands of different persons, in particular the left hands of different persons, or the right hands of different persons.

After training the first algorithm model, the second image and the second label corresponding to the second image are input into the first algorithm model to generate the second avatar. The first avatar and the second avatar are implicit avatars, which may be avatars described by implicit relationships such as functions.

In the implicit modeling method of the related art, an avatar is generated only according to an input image and a label, and at this time, since there is only a single second image and a corresponding second label, the generated avatar has a poor effect and is easily distorted. In some embodiments of the present disclosure, the first algorithm model is an advanced implicit modeling method that generates an avatar that is an implicit avatar. When the first algorithm model generates a second avatar according to the second image and the second label, the second avatar is generated on the basis of the first avatar, and since the first avatar and the second avatar are avatars of homogenous objects, they have an extremely high degree of similarity with each other, and thus the generated second avatar is more realistic. An embodiment of the present disclosure provides a method for generating a drivable implicit second avatar using only a single second image, which can achieve high fidelity on the basis of the properties of the implicit expression. The embodiment of the present disclosure implements generation of an implicit second avatar on the basis of a single graph, reducing data volume requirements.

In some embodiments of the present disclosure, inputting a single second image of a second object and a second label corresponding to the second image into the first algorithm model trained such that the first algorithm model generates a second avatar of the second object according to the first avatar includes: generating a third avatar according to the first avatar, and generating one or more third images with a different viewing angle from the second image according to the third avatar; adjusting the third avatar to reduce a residual error between the second image and a fourth image and a residual error between the third image and a fifth image, wherein the fourth image is an image of the second object having a same viewing angle as the second image and generated by using an adjusted third avatar, and the fifth image is an image of the second object having a same viewing angle as the third image and generated by using the adjusted third avatar; and taking the adjusted third avatar as the second avatar.

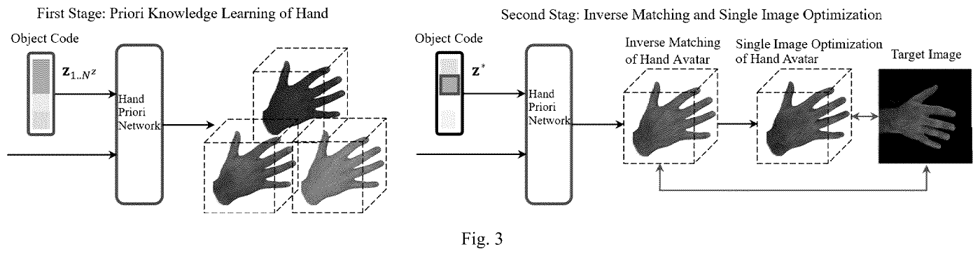

In some embodiments, taking the object is a hand as an example, as shown in FIGS. 2 and 3, the method in an embodiment of the present disclosure may include two stages. In a first stage, multi-view images and corresponding first labels of different first objects (such as Object A, Object B and Object C, specifically, hands of different persons) are input, training is performed in the first algorithm model (such as a hand priori network) to generate a plurality of first avatars (such as respective hand avatars of a plurality of persons), and then the second object (such as Object X) is input into the first algorithm model (such as a hand priori network) to perform inverse matching, whereby a third avatar (such as hand avatar) closest to the second object is thus obtained. A residual error between an image and the second image is small, and satisfies the requirement for the residual error, wherein the image is generated on the basis of the third avatar and has the same viewing angle as the second image. Single image optimization is performed on the third avatar (namely, the third avatar is adjusted), and before the optimization on the basis of the single image, an unadjusted third avatar is used to generate one or more third images, wherein the third image is an image of the second object, and the viewing angle of the third image is different from that of the second image, and the number of viewing angles of the plurality of third images can be multiple, namely, the third images with different viewing angles are generated. Then the third avatar is adjusted, a fourth image of the second object having the same viewing angle as the second image and a fifth image of the second object having the same viewing angle as the third image are generated using the adjusted third avatar, a number of the fifth image(s) and the viewing angle(s) thereof can be the same as those of the third image(s), and a residual error between the second image and the fourth image and a residual error between the third image and the fifth image are calculated. By continuously adjusting the third avatar, regenerating the fourth image and the fifth image and calculating the residual errors, the two residual errors are minimized, and in particular a sum of the two residual errors is minimized. In single image optimization, an image reconstruction loss function and a viewing angle regularization loss function can be used, and the purpose of using the viewing angle regularization loss function is to make the third images of multiple viewing angles before single image optimization consistent with the fifth image after single image optimization as much as possible. In the embodiment of the present disclosure, when optimization is performed, not only the image of the same viewing angle as a second viewing angle but also the image of an viewing angle different from the second viewing angle are taken into consideration, and the generated second avatar is made more realistic and closer to the second object by optimization of the images of a plurality of viewing angles.

In some embodiments of the present disclosure, generating a third avatar according to the first avatar includes: determining a parameter of an object code and a color correction parameter of each of the first objects, wherein one object code is used to represent one object, and an avatar of the object represented by the object code is able to be obtained through the object code; and synthesizing the third avatar with each of the first avatars according to the parameter of the object code of the first objects; and synthesizing a color of the third avatar with a color of the first avatar according to the color correction parameter.

In some embodiments, each first object has a corresponding object code, the parameter of the object code may be a representation of a part or weight of each first avatar which constituting the third avatar. The third avatar may be obtained by combining one or more first avatars, and, similarly, the color of the third avatar may also be obtained by combining color(s) of one or more first avatars, and the color correction parameter may represent the corresponding part or weight of the color of each first avatar in the third avatar. By adjusting the parameter of the object code and the color correction parameter, a shape and a color of the third avatar can be adjusted. The color of the third avatar may, for example, include its three-dimensional texture information. Specifically, in the inverse matching process of FIGS. 2 and 3, the third avatar is generated, and then a residual error between an image and the second image is determined using the image reconstruction loss function, wherein the image is generated on the basis of the third avatar and has the same viewing angle as the second image, and the third avatar is adjusted to reduce the residual error by optimizing the parameter of the object code and the color correction parameter.

In some embodiments of the present disclosure, adjusting the third avatar includes that: in some embodiments, the present step may be a step of single image optimization in FIGS. 2 and 3. When the single image optimization is performed, specifically when optimization is performed, a multilayer perceptron in the first algorithm model which is responsible for generating texture information of the avatar, is adjusted and the three-dimensional texture information of the third avatar is adjusted by adjusting the multilayer perceptron so as to make an image of the second object in another viewing angle match the second image, and thus the generated third avatar not only matches the second image in the viewing angle of the second image, but also matches the second image in another viewing angle. In some embodiments, the method proposed by the present disclosure can control and drive the second avatar to change the pose after the second avatar is generated, and can also generate an image with the same viewing angle as or different viewing angles from the second image on the basis of rendering the second avatar. Since the training stage reduces the residual error between the fourth image and the second image and the residual error between the third image and the fifth image, when the second avatar is rendered to generate an image with the same or different viewing angle as the second viewing angle on the basis of a changed pose or an unchanged pose, an image conforming to the actual situation can be obtained, which is more life-like.

In some embodiments of the present disclosure, training a first algorithm model using a first image of a first object and a first label corresponding to the first image includes: generating the first avatar of the first object using the first image and the first label corresponding to the first image; generating a sixth image of the first object according to the first avatar; and adjusting the first avatar to reduce a residual error between the sixth image regenerated on the basis of an adjusted first avatar and the first image.

In some embodiments, in training the first algorithm model, the first avatar of the first object is first generated according to the first image of the first object and the first label, the first label being pre-annotated for the first image. After the first avatar is generated, an image having the first object is generated as the sixth image (the image of any object has the object therein) on the basis of rendering the first avatar, and the sixth image may have the same viewing angle as the first image used for training, and then the residual error between the first image of the first object used for training and the sixth image of the first object is calculated, and specifically an image reconstruction loss function may be used, wherein the image reconstruction loss function may include learned perceptual image patch similarity (LPIPS) and an L1 loss function (absolute value loss function). Then the first avatar is iteratively adjusted continuously, and the generated sixth image is re-rendered on the basis of the adjusted first avatar such that a residual error between the sixth image generated via re-rendering and the first image decreases until the residual error value is less than a pre-set residual error value or the number of times of iterations reaches a pre-set number.

In some embodiments of the present disclosure, generating the first avatar of the first object using the first image and the first label corresponding to the first image includes: determining a geometry of the first object according to a sampling point in the first image, and an object pose and an object mesh of the first object in the first image; determining three-dimensional texture information of the first object according to an object code of the first object in the first image, the sampling point and the object mesh of the first object in the first image; determining shadow information of the first object according to the sampling point in the first image, the object mesh of the first object in the first image, and the object pose of the first object in the first image; and obtaining the first avatar of the first object according to the geometry of the first object, the three-dimensional texture information of the first object and a shadow value of the first avatar, wherein the first label includes: the object pose and the object mesh of the first object in the first image.

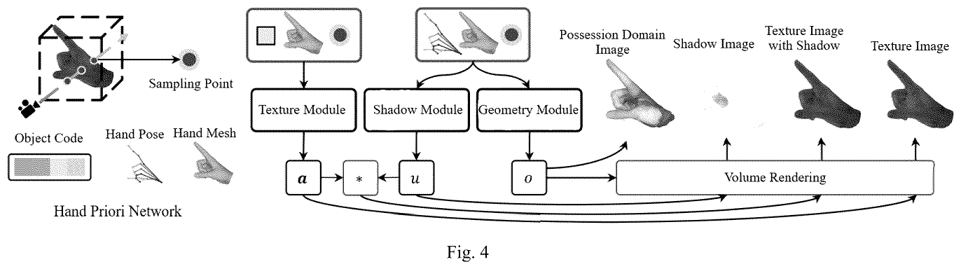

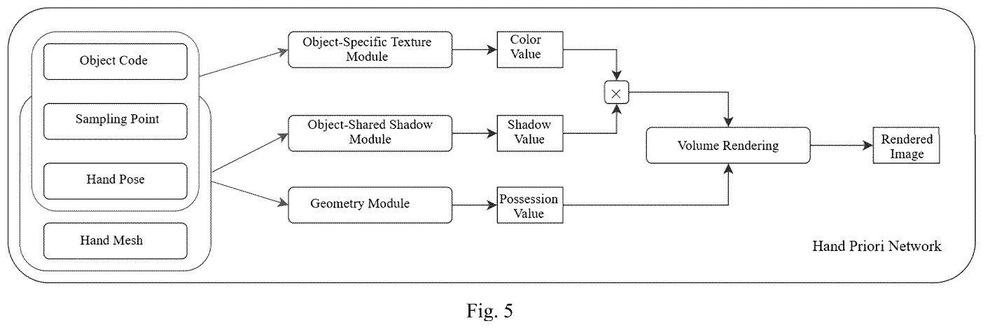

In some embodiments, as shown in FIGS. 4 and 5, the first algorithm model may include a texture module, a shadow module, and a geometry module, wherein different objects each have one texture module and all objects share one shadow module. The input to the geometry module includes the sampling point, the object mesh and the object pose (for example, the object may be a hand, and different objects may be hands of different persons). The geometry module is configured for determining the geometry of the object. The input to the texture module includes the sampling point, the object mesh and the object code, wherein different objects each have a corresponding texture module. The texture module is configured for determining the three-dimensional texture information of the corresponding object. The inputs to the shadow module include the sampling point, the object mesh and the object pose, which are used to determine the shadow information of the object in a particular pose (for example, in an image generated on the basis of an avatar of the object, wherein the shadow information of the object is generated according to a viewing angle of the image). The object pose and the object mesh can be retrieved from the label. The object code may be a learnable one-dimensional eigenvector (for example, the dimension can be 1×33), which is used to represent a certain object, and an avatar of the corresponding object can be obtained through the object code. The first avatar can be generated and displayed by obtaining the geometry of the first object, the texture information and the shadow information of the viewing angle corresponding to the first avatar to be generated.

In some embodiments of the present disclosure, the geometry of the first object is determined in the geometry module, inputs to the geometry module include the sampling point, the object mesh and the object pose, and an output of the geometry module includes an possession value corresponding to the sampling point. The sampling point is a point in a three-dimensional space (for example, a control where an avatar is located) converted by all pixels in an input image (e.g. the first image, the second image, etc.), the number of the sampling point is N, and the total dimension is N×3. The object mesh is represented by a vertex position in the object mesh structure. The object pose is a relative rotation angle between key points (usually bone points) of the object. In the geometry module, an object possession domain is created, which may be an implicit expression describing whether a point in the three-dimensional space is located on an object surface. For a point in a given three-dimensional space, the probability of the point being located on the object surface can be obtained through the geometry module. Using such an object possession domain, the probability of each point being located on the object surface can be obtained by densely sampling in the three-dimensional space, and then the possession values of N points can be determined according to the probability, while the dimension is N×1. Specifically, the possession value is 0 or 1, and if the probability that a point is on the object surface is greater than a preset probability (for example, 50%), the possession value of the point is considered to be 1, otherwise it is 0. The points having a value of 1 constitute the surface of the object, thereby forming the geometry of the object.

In some embodiments of the present disclosure, the determining three-dimensional texture information of the first object according to an object code of the first object in the first image, the sampling point and the object mesh of the first object in the first image includes: creating an object texture domain of the first object; and determining the texture value of the sampling point on the basis of the object texture domain and according to the object code of the first object, the sampling point and the object mesh of the first object in the first image, to obtain the three-dimensional texture information of the first avatar.

In some embodiments, determining the three-dimensional texture information of the first avatar is performed in the texture module, and different first objects each have one corresponding texture module since the three-dimensional texture information is different. The inputs to the texture module include the sampling point, the object mesh and the object code. The object code may be a learnable one-dimensional eigenvector (e.g. the dimension can be 1×33), which is used to represent a certain object, and an avatar of the corresponding object can be obtained through the texture module according to the object code. In the texture module, it is used to create one object texture domain (e.g. hand texture domain), which may be an implicit expression of the texture values describing different points in the three-dimensional space. Given a point in the three-dimensional space and a corresponding object code, the texture value of a specified object corresponding to the point can be obtained through the texture module. With this object texture domain, volume rendering can be performed with large-scale dense sampling in the three-dimensional space, so as to obtain the three-dimensional texture information of the object.

In some embodiments of the present disclosure, the determining the texture value of the sampling point on the basis of the object texture domain and according to the object code of the first object, the sampling point and the object mesh of the first object in the first image, to obtain the three-dimensional texture information of the first avatar includes: performing point cloud sampling at different resolutions on an input object mesh, and assigning one first eigenvector to each point in the point cloud; at each resolution, for each input sampling point, determining at least four nearest points to the sampling point in the point cloud, performing weighted averaging on the first eigenvectors of the at least four nearest points according to inverse ratios of distances between the sampling point and the at least four nearest points to obtain a first sampling feature of the sampling point, and inputting the first sampling feature and the object code of the first object into a multilayer perceptron of four layers for regression to obtain a first hidden layer feature at the resolution; and inputting the first hidden layer feature at each resolution into a multilayer perceptron of three layers to obtain the texture value.

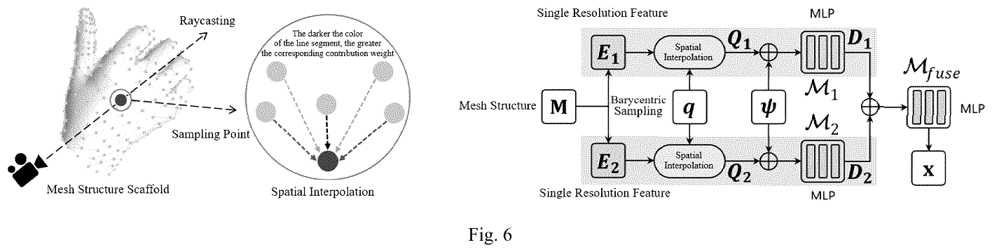

In some embodiments, the object texture domain in the texture module of the present disclosure differs from the related art in that it includes: a texture multi-resolution domain. The object texture domain is an implicit expression of the three-dimensional texture information, and the following specifically describes steps performed by using the implicit expression to obtain the texture value. The above-mentioned steps can be steps performed in the texture multi-resolution domain, and the inputs to the texture multi-resolution domain include: the sampling point, the object mesh and the object code, while an output of the texture multi-resolution domain includes: a texture value. As shown on the right side of FIG. 6, point cloud sampling is performed at different resolutions according to an input object mesh M, namely, the point cloud sampling is performed at different quantities of point clouds Mk (wherein Mk can be 512, 1024, 2048, etc.), one quantity of the point clouds corresponds to one resolution, and one first eigenvector with a dimension C is assigned to each point sampled by the point cloud sampling, forming a single resolution feature E of MkxC (for example, E1 and E2 at different resolutions in the right side of FIG. 6), and C can be 32, 64, 128, etc. The same operations are performed at each resolution as follows: as shown on the left side of FIG. 6, for each sampling point, the distances between the sampling point and the nearest four points in the point cloud (kx4 points in total, k is the number of sampling points) are calculated, and then a first sampling feature Q (for example, Q1 and Q2 at different resolutions in FIG. 6) of the sampling point is obtained by performing weighted averaging (e.g. a spatial difference value in FIG. 6) using first eigenvectors of the four points, with the weight of each of the four points being inversely proportional to the distance to the sampling point. The sampling feature and the object code (w on the right side of FIG. 6) are input into a multilayer perceptron (MLP) of four layers for regression to obtain a first hidden layer feature D at the resolution (for example, D1 and D2 at different resolutions in FIG. 6). Finally, the first hidden layer features at all resolutions are input into a multilayer perceptron of three layers to obtain the texture value x. In use, the texture value can be determined through the texture multi-resolution domain, and the texture multi-resolution domain is adopted, so that the authenticity of the three-dimensional texture information can be further improved by performing point cloud sampling under different resolutions and considering the comprehensive situation under different resolutions.

In some embodiments of the present disclosure, the determining shadow information of the first object according to the sampling point in the first image, the object mesh of the first object in the first image, and the object pose of the first object in the first image includes: creating an object shadow domain according to the object mesh; and determining a shadow value of the sampling point under the object pose according to the object shadow domain, to obtain the shadow information of the first avatar.

In some embodiments, a shared shadow module is employed in the first algorithm model, and the inputs to the shadow module include the sampling point, the object mesh, and the object pose. The shadow module creates one object shadow domain, which may be an implicit expression of the shadow values that describe a point in the three-dimensional space under different poses of the avatar. Given one point and a corresponding object pose in the three-dimensional space, the shadow value corresponding to the point can be obtained through the hand shadow domain. With this object shadow domain, the shadow information (such as shadow caused by natural occlusion) of an object in a given object pose can be obtained by large-scale dense sampling in the three-dimensional space.

In some embodiments of the present disclosure, the determining a shadow value of the sampling point under the object pose on the basis of the object shadow domain and according to the sampling point in the first image, the object mesh of the first object in the first image and the object pose of the first object in the first image includes: performing point cloud sampling at different resolutions on an input object mesh, and assigning one second eigenvector to each point in the point cloud; at each resolution, for each input sampling point, determining at least four nearest points to the sampling point in the point cloud, performing weighted averaging on the second eigenvectors of the at least four nearest points according to inverse ratios of distances between the sampling point and the at least four nearest points to obtain a second sampling feature of the sampling point, and inputting the second sampling feature and the object pose of the first object into a multilayer perceptron of four layers for regression to obtain a second hidden layer feature at the resolution; and inputting the second hidden layer feature at each resolution into a multilayer perceptron of three layers to obtain the shadow value.

In some embodiments, similar to the texture module, the shadow module includes a shadow multi-resolution domain. The object shadow domain is an implicit expression of the shadow information, and the following specifically describes steps performed by using the implicit expression to obtain the shadow value; the above-mentioned steps can be steps performed in the shadow multi-resolution domain. The inputs to the shadow multi-resolution domain include: the sampling point, the object mesh and the object code, and an output of the shadow multi-resolution domain includes: a texture value. Point cloud sampling is performed at different resolutions according to an input object mesh, namely, the point cloud sampling is performed at different quantities of point clouds, one quantity of the point clouds corresponds to one resolution, and one second eigenvector is assigned to each point sampled by the point cloud sampling. The same operations are performed at each resolution as follows: for each sampling point, the distances between the sampling point and the nearest four points in the point cloud are calculated, and then a second sampling feature of the sampling point is obtained by performing weighted averaging using second eigenvectors of the four points, with the weight of each of the four points being inversely proportional to the distance to the sampling point. The sampling feature and the object pose are input into a multilayer perceptron (MLP) of four layers for regression to obtain a second hidden layer feature at the resolution. Finally, the second hidden layer features at all resolutions are input into a multilayer perceptron of three layers to obtain the shadow value. In use, the shadow value of a point under a given object pose can be sampled by the shadow multi-resolution domain, so that the first avatar shadow information can be obtained by means of large-scale dense sampling, thereby further improving the authenticity of the shadow information.

In some embodiments of the present disclosure, the method further includes that: the second avatar is used to render an image of the second object at a specified viewing angle, an editing operation is performed on the rendered image, and the edited content and the position of the object therein are recorded. The edited content and the position of the object are input into the first algorithm model, and the second avatar is adjusted so that adjusted second avatar matches the edited content. In some embodiments, if there is a difference between the second avatar and the actual situation, the user may adjust the second avatar by manually editing the rendered image and using the edited image to adjust the second avatar, and specifically may minimize the residual errors between the images of different viewing angles generated by the second avatar and the edited image.

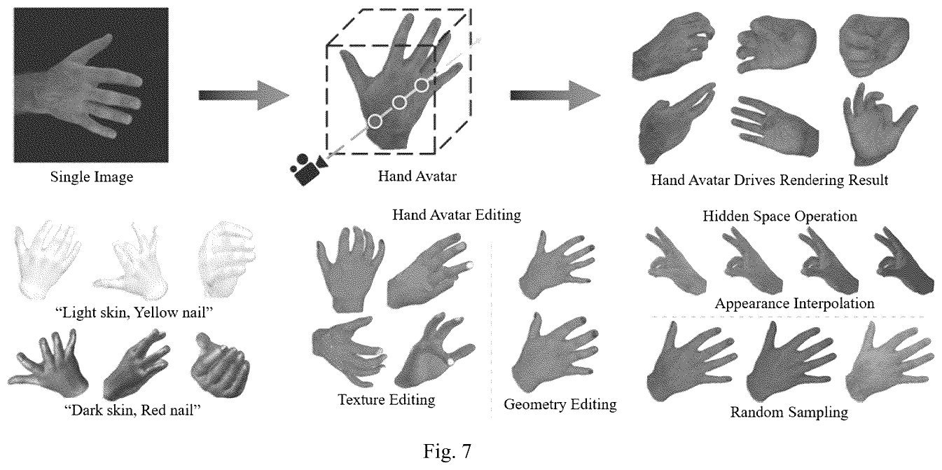

In some embodiments, a second algorithmic model is a model for generating an image using text, and the method further includes that: a corresponding avatar may be generated by generating a specified image in the second algorithmic model using text (e.g. “light skin, yellow nail” and “dark skin, red nail” in the bottom left of FIG. 7) and then inputting the specified image into the first algorithm model trained. This enables the function of generating an avatar of specified text.

In some embodiments of the present disclosure, the method further includes: adjusting a geometry of the second avatar in response to changing the object mesh and/or a geometry parameter of the second avatar. In some embodiments, as shown in FIG. 7, geometric editing may be performed on the generated second avatar. When geometric editing is performed, the object mesh or its geometry parameter can be changed to complete the geometric editing.

In some embodiments of the present disclosure, the object code for each object may be separated as a whole, then randomly sampled, and a new avatar generated using the randomly sampled object code. Thus, the function of generating a new avatar from an existing avatar is achieved. Specifically, the second avatar of the second object may be generated in the same manner as the first avatar.

In some embodiments of the present disclosure, the method further includes: acquiring object codes of at least two objects, performing interpolation calculation using the at least two object codes, and generating a fourth avatar using the object codes subjected to interpolation calculation, wherein an appearance of the fourth avatar is an interpolation calculation result of the avatars of the at least two objects (which may include a first object or a second object). In some embodiments, a linear difference calculation may be performed on a plurality of object codes, and then a corresponding fourth avatar is generated using the calculated object codes, wherein the appearance of the fourth avatar is an interpolation calculation result of the avatars corresponding to the plurality of object codes.

In the method in some embodiments of the present disclosure, the object in the present disclosure is a hand, and a drivable implicit hand avatar can be generated using only a single image, and high fidelity can be achieved on the basis of the characteristics of the implicit expression thereof; and the proposed method can support text generation of hand avatar, hand avatar editing and hidden space operations of hand avatar object (random sampling and appearance interpolation calculation). The present disclosure uses a shadow module shared by a multi-resolution domain and the object to learn high-quality hand existing information and migrate it into single map generation to make the hand avatar more realistic. The method of the present disclosure can generate a high-fidelity hand avatar on the basis of a single map with consistent driving performance; and, at the same time, for a variety of different inputs, it has better robustness and improves the sense of reality.

The present disclosure provides an apparatus for generating a virtual avatar, including:
a training unit configured for training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
a generation unit configured for inputting a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object.

In some embodiments, the inputting a single second image of a second object and a second label corresponding to the second image into the first algorithm model trained such that the first algorithm model generates a second avatar of the second object according to the first avatar includes:
generating a third avatar according to the first avatar;
generating one or more third images with a different viewing angle from the second image according to the third avatar; and
adjusting the third avatar to reduce a residual error between the second image and a fourth image and a residual error between the third image and a fifth image, wherein the fourth image is an image of the second object having a same viewing angle as the second image and generated by using an adjusted third avatar, and the fifth image is an image of the second object having a same viewing angle as the third image and generated by using the adjusted third avatar; and taking the adjusted third avatar as the second avatar.

In some embodiments, the generating a third avatar according to the first avatar includes: determining a parameter of an object code and a color correction parameter of each of the first
objects, wherein one object code is used to represent one object, and an avatar of the object represented by the object code is able to be obtained through the object code; and
synthesizing the third avatar with each of the first avatars according to the parameter of the object code of the first objects; and synthesizing a color of the third avatar with a color of the first avatar according to the color correction parameter.

In some embodiments, adjusting the third avatar includes:
adjusting a multilayer perceptron in the first algorithm model, wherein the multilayer perceptron in the first algorithm model is used for generating three-dimensional texture information of an avatar.

In some embodiments, the training a first algorithm model using a first image of a first object and a first label corresponding to the first image includes:
generating the first avatar of the first object using the first image and the first label corresponding to the first image;
generating a sixth image of the first object according to the first avatar; and
adjusting the first avatar to reduce a residual error between the sixth image regenerated on the basis of an adjusted first avatar and the first image.

In some embodiments, the generating the first avatar of the first object using the first image and the first label corresponding to the first image includes:
determining a geometry of the first object according to a sampling point in the first image, and an object pose and an object mesh of the first object in the first image;
determining three-dimensional texture information of the first object according to an object code of the first object in the first image, the sampling point and the object mesh of the first object in the first image;
determining shadow information of the first object according to the sampling point in the first image, the object mesh of the first object in the first image, and the object pose of the first object in the first image; and
obtaining the first avatar of the first object according to the geometry of the first object, the three-dimensional texture information of the first object and a shadow value of the first avatar,
wherein the first label includes: the object pose and the object mesh of the first object in the first image.

In some embodiments, the determining three-dimensional texture information of the first object according to an object code of the first object in the first image, the sampling point and the object mesh of the first object in the first image includes:
creating an object texture domain of the first object; and determining the texture value of the sampling point on the basis of the object texture domain and according to the object code of the first object, the sampling point and the object mesh of the first object in the first image, to obtain the three-dimensional texture information of the first avatar.

In some embodiments, the determining the texture value of the sampling point on the basis of the object texture domain and according to the object code of the first object, the sampling point and the object mesh of the first object in the first image includes:
performing point cloud sampling at different resolutions on an input object mesh, and assigning one first eigenvector to each point in the point cloud; at each resolution, for each input sampling point, determining at least four nearest points to the sampling point in the point cloud, performing weighted averaging on the first eigenvectors of the at least four nearest points according to inverse ratios of distances between the sampling point and the at least four nearest points to obtain a first sampling feature of the sampling point, and inputting the first sampling feature and the object code of the first object into a multilayer perceptron of four layers for regression to obtain a first hidden layer feature at the resolution; and inputting the first hidden layer feature at each resolution into a multilayer perceptron of three layers to obtain the texture value.

In some embodiments, the determining shadow information of the first object according to the sampling point in the first image, the object mesh of the first object in the first image, and the object pose of the first object in the first image includes:
creating an object shadow domain; and
determining a shadow value of the sampling point under the object pose on the basis of the object shadow domain and according to the sampling point in the first image, the object mesh of the first object in the first image and the object pose of the first object in the first image, to obtain the shadow information of the first avatar.

In some embodiments, the determining a shadow value of the sampling point under the object pose on the basis of the object shadow domain and according to the sampling point in the first image, the object mesh of the first object in the first image and the object pose of the first object in the first image includes:
performing point cloud sampling at different resolutions on an input object mesh, and assigning one second eigenvector to each point in the point cloud; at each resolution, for each input sampling point, determining at least four nearest points to the sampling point in the point cloud, performing weighted averaging on the second eigenvectors of the at least four nearest points according to inverse ratios of distances between the sampling point and the at least four nearest points to obtain a second sampling feature of the sampling point, and inputting the second sampling feature and the object pose of the first object into a multilayer perceptron of four layers for regression to obtain a second hidden layer feature at the resolution; and inputting the second hidden layer feature at each resolution into a multilayer perceptron of three layers to obtain the shadow value.

In one embodiment, the method further includes one or more selected from the group consisting of:
adjusting a geometry of the second avatar in response to changing the object mesh and/or a geometry parameter of the second avatar;
acquiring object codes of at least two objects, performing interpolation calculation using the at least two object codes, and generating a fourth avatar using the object codes subjected to interpolation calculation, wherein an appearance of the fourth avatar is an interpolation calculation result of the avatars of the at least two objects; and
the first object and the second object each being hands of different persons.

In particular, for the apparatus embodiments, which are substantially corresponding to the method embodiments, reference can be made to the partial description of the method embodiments. The apparatus embodiments described above are merely illustrative, wherein the modules illustrated as separate modules may or may not be separated. Some or all of the modules therein may be selected to achieve the object of the solution of the present embodiment according to actual needs. A person skilled in the art would have been able to understand and implement the embodiments without involving any inventive effort.

The method and apparatus of the present disclosure have been described above on the basis of embodiments and application examples. In addition, the present disclosure provides an electronic device and a computer-readable storage medium, which are described below.

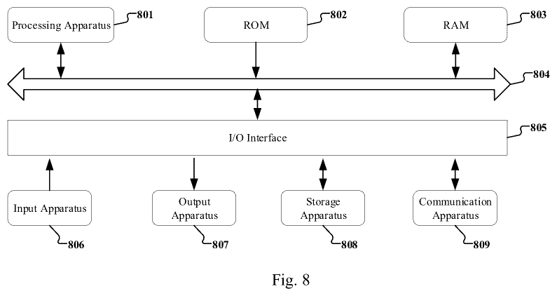

Referring to FIG. 8, FIG. 8 illustrates a schematic structural diagram of an electronic device 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 8 is merely an example, and should not pose any limitation to the functions and the range of use of the embodiments of the present disclosure.

The electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 8 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to implement the above method in the present disclosure.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, there is provided a method for generating a virtual avatar including:
training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
inputting a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.

According to one or more embodiments of the present disclosure, there is provided a method for generating a virtual avatar, wherein the inputting a single second image of a second object and a second label corresponding to the second image into the first algorithm model trained such that the first algorithm model generates a second avatar of the second object according to the first avatar includes:
generating a third avatar according to the first avatar, and generating one or more third images with a different viewing angle from the second image according to the third avatar; and adjusting the third avatar to reduce a residual error between the second image and a fourth image and a residual error between the third image and a fifth image, wherein the fourth image is an image of the second object having a same viewing angle as the second image and generated by using an adjusted third avatar, and the fifth image is an image of the second object having a same viewing angle as the third image and generated by using the adjusted third avatar; and
taking the adjusted third avatar as the second avatar.

According to one or more embodiments of the present disclosure, there is provided a method for generating a virtual avatar, wherein the generating a third avatar according to the first avatar includes:
determining a parameter of an object code and a color correction parameter of each of the first objects, wherein one object code is used to represent one object, and an avatar of the object represented by the object code is able to be obtained through the object code; and
synthesizing the third avatar with each of the first avatars according to the parameter of the object code of the first objects; and synthesizing a color of the third avatar with a color of the first avatar according to the color correction parameter.

According to one or more embodiments of the present disclosure, there is provided a method for generating a virtual avatar, wherein the adjusting the third avatar includes:
adjusting a multilayer perceptron in the first algorithm model, wherein the multilayer perceptron in the first algorithm model is used for generating three-dimensional texture information about an avatar.

According to one or more embodiments of the present disclosure, there is provided a method for generating a virtual avatar, wherein the training a first algorithm model using a first image of a first object and a first label corresponding to the first image includes:
generating the first avatar of the first object using the first image and the first label corresponding to the first image;
generating a sixth image of the first object according to the first avatar; and
adjusting the first avatar to reduce a residual error between the sixth image regenerated on the basis of an adjusted first avatar and the first image.

According to one or more embodiments of the present disclosure, there is provided a method for generating a virtual avatar, wherein the generating the first avatar of the first object using the first image and the first label corresponding to the first image includes:
determining a geometry of the first object according to a sampling point in the first image, and an object pose and an object mesh of the first object in the first image;
determining three-dimensional texture information of the first object according to an object code of the first object in the first image, the sampling point and the object mesh of the first object in the first image;
determining shadow information of the first object according to the sampling point in the first image, the object mesh of the first object in the first image, and the object pose of the first object in the first image; and
obtaining the first avatar of the first object according to the geometry of the first object, the three-dimensional texture information of the first object and a shadow value of the first avatar,
wherein the first label includes: the object pose and the object mesh of the first object in the first image.

According to one or more embodiments of the present disclosure, there is provided a method for generating a virtual avatar, wherein the determining three-dimensional texture information of the first object according to an object code of the first object in the first image, the sampling point and the object mesh of the first object in the first image includes:
creating an object texture domain of the first object; and determining the texture value of the sampling point on the basis of the object texture domain and according to the object code of the first object, the sampling point and the object mesh of the first object in the first image, to obtain the three-dimensional texture information of the first avatar.

According to one or more embodiments of the present disclosure, there is provided a method for generating a virtual avatar, wherein the determining the texture value of the sampling point on the basis of the object texture domain and according to the object code of the first object, the sampling point and the object mesh of the first object in the first image includes:
performing point cloud sampling at different resolutions on an input object mesh, and assigning one first eigenvector to each point in the point cloud; at each resolution, for each input sampling point, determining at least four nearest points to the sampling point in the point cloud, performing weighted averaging on the first eigenvectors of the at least four nearest points according to inverse ratios of distances between the sampling point and the at least four nearest points to obtain a first sampling feature of the sampling point, and inputting the first sampling feature and the object code of the first object into a multilayer perceptron of four layers for regression to obtain a first hidden layer feature at the resolution; and inputting the first hidden layer feature at each resolution into a multilayer perceptron of three layers to obtain the texture value.

According to one or more embodiments of the present disclosure, there is provided a method for generating a virtual avatar, wherein the determining shadow information of the first object according to the sampling point in the first image, the object mesh of the first object in the first image, and the object pose of the first object in the first image includes:
creating an object shadow domain; and
determining a shadow value of the sampling point under the object pose on the basis of the object shadow domain and according to the sampling point in the first image, the object mesh of the first object in the first image and the object pose of the first object in the first image, to obtain the shadow information of the first avatar.

According to one or more embodiments of the present disclosure, there is provided a method for generating a virtual avatar, wherein the determining a shadow value of the sampling point under the object pose on the basis of the object shadow domain and according to the sampling point in the first image, the object mesh of the first object in the first image and the object pose of the first object in the first image includes:
performing point cloud sampling at different resolutions on an input object mesh, and assigning one second eigenvector to each point in the point cloud; at each resolution, for each input sampling point, determining at least four nearest points to the sampling point in the point cloud, performing weighted averaging on the second eigenvectors of the at least four nearest points according to inverse ratios of distances between the sampling point and the at least four nearest points to obtain a second sampling feature of the sampling point, and inputting the second sampling feature and the object pose of the first object into a multilayer perceptron of four layers for regression to obtain a second hidden layer feature at the resolution; and inputting the second hidden layer feature at each resolution into a multilayer perceptron of three layers to obtain the shadow value.

According to one or more embodiments of the present disclosure, there is provided a method for generating a virtual avatar, further including one or more selected from the group consisting of:
adjusting a geometry of the second avatar in response to changing the object mesh and/or a geometry parameter of the second avatar;
acquiring object codes of at least two objects, performing interpolation calculation using the at least two object codes, and generating a fourth avatar using the object codes subjected to interpolation calculation, wherein an appearance of the fourth avatar is an interpolation calculation result of the avatars of the at least two objects;
the first object and the second object each being hands of different persons; and
the first avatar and the second avatar being implicit avatars.

According to one or more embodiments of the present disclosure, there is provided an apparatus for generating a virtual avatar, including:
a training unit configured for training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
a generation unit configured for inputting a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.

According to one or more embodiments of the present disclosure, there is provided an electronic device including: at least one memory and at least one processor,
wherein the at least one memory is configured for storing program codes, and the at least one processor is configured for calling the program codes stored in the at least one memory to perform the method according to any one solution described above.

According to one or more embodiments of the present disclosure, there is provided a computer-readable storage medium, configured for storing program codes, wherein the program codes, when executed by a processor, cause the processor to perform the method described above.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for generating a virtual avatar, comprising:
training a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
inputting a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.

2. The method according to claim 1, wherein the inputting a single second image of a second object and a second label corresponding to the second image into the first algorithm model trained such that the first algorithm model generates a second avatar of the second object according to the first avatar comprises:
generating a third avatar according to the first avatar;
generating one or more third images with a different viewing angle from the second image according to the third avatar; and
adjusting the third avatar to reduce a residual error between the second image and a fourth image and a residual error between the third image and a fifth image, wherein the fourth image is an image of the second object having a same viewing angle as the second image and generated by using an adjusted third avatar, and the fifth image is an image of the second object having a same viewing angle as the third image and generated by using the adjusted third avatar; and taking the adjusted third avatar as the second avatar.

3. The method according to claim 2, wherein the generating a third avatar according to the first avatars comprises:
determining a parameter of an object code and a color correction parameter of each of the first objects, wherein one object code is used to represent one object, and an avatar of the object represented by the object code is able to be obtained through the object code; and
synthesizing the third avatar with each of first avatars according to the parameter of the object code of the first objects; and synthesizing a color of the third avatar with a color of the first avatar according to the color correction parameter.

4. The method according to claim 2, wherein the adjusting the third avatar comprises:
adjusting a multilayer perceptron in the first algorithm model, wherein the multilayer perceptron in the first algorithm model is used for generating three-dimensional texture information of an avatar.

5. The method according to claim 1, wherein the training a first algorithm model using a first image of a first object and a first label corresponding to the first image comprises:
generating the first avatar of the first object using the first image and the first label corresponding to the first image;
generating a sixth image of the first object according to the first avatar; and
adjusting the first avatar to reduce a residual error between the sixth image regenerated on the basis of an adjusted first avatar and the first image.

6. The method according to claim 5, wherein the generating the first avatar of the first object using the first image and the first label corresponding to the first image comprises:
determining a geometry of the first object according to a sampling point in the first image, and an object pose and an object mesh of the first object in the first image;
determining three-dimensional texture information of the first object according to an object code of the first object in the first image, the sampling point and the object mesh of the first object in the first image;
determining shadow information of the first object according to the sampling point in the first image, the object mesh of the first object in the first image, and the object pose of the first object in the first image; and
obtaining the first avatar of the first object according to the geometry of the first object, the three-dimensional texture information of the first object and a shadow value of the first avatar,
wherein the first label comprises: the object pose and the object mesh of the first object in the first image.

7. The method according to claim 6, wherein the determining three-dimensional texture information of the first object according to an object code of the first object in the first image, the sampling point and the object mesh of the first object in the first image comprises:
creating an object texture domain of the first object; and determining the texture value of the sampling point on the basis of the object texture domain and according to the object code of the first object, the sampling point and the object mesh of the first object in the first image, to obtain the three-dimensional texture information of the first avatar.

8. The method according to claim 7, wherein the determining the texture value of the sampling point on the basis of the object texture domain and according to the object code of the first object, the sampling point and the object mesh of the first object in the first image comprises:
performing point cloud sampling at different resolutions on an input object mesh, and assigning one first eigenvector to each point in the point cloud; at each resolution, for each input sampling point, determining at least four nearest points to the sampling point in the point cloud, performing weighted averaging on the first eigenvectors of the at least four nearest points according to inverse ratios of distances between the sampling point and the at least four nearest points to obtain a first sampling feature of the sampling point, and inputting the first sampling feature and the object code of the first object into a multilayer perceptron of four layers for regression to obtain a first hidden layer feature at the resolution; and inputting the first hidden layer feature at each resolution into a multilayer perceptron of three layers to obtain the texture value.

9. The method according to claim 6, wherein the determining shadow information of the first object according to the sampling point in the first image, the object mesh of the first object in the first image, and the object pose of the first object in the first image comprises:
creating an object shadow domain; and
determining a shadow value of the sampling point under the object pose on the basis of the object shadow domain and according to the sampling point in the first image, the object mesh of the first object in the first image and the object pose of the first object in the first image, to obtain the shadow information of the first avatar.

10. The method according to claim 9, wherein the determining a shadow value of the sampling point under the object pose on the basis of the object shadow domain and according to the sampling point in the first image, the object mesh of the first object in the first image and the object pose of the first object in the first image comprises:
performing point cloud sampling at different resolutions on an input object mesh, and assigning one second eigenvector to each point in the point cloud; at each resolution, for each input sampling point, determining at least four nearest points to the sampling point in the point cloud, performing weighted averaging on the second eigenvectors of the at least four nearest points according to inverse ratios of distances between the sampling point and the at least four nearest points to obtain a second sampling feature of the sampling point, and inputting the second sampling feature and the object pose of the first object into a multilayer perceptron of four layers for regression to obtain a second hidden layer feature at the resolution; and inputting the second hidden layer feature at each resolution into a multilayer perceptron of three layers to obtain the shadow value.

11. The method according to claim 1, further comprising one or more selected from the following:
adjusting a geometry of the second avatar in response to changing the object mesh and/or a geometry parameter of the second avatar;
acquiring object codes of at least two objects, performing interpolation calculation using the at least two object codes, and generating a fourth avatar using the object codes subjected to interpolation calculation, wherein an appearance of the fourth avatar is an interpolation calculation result of the avatars of the at least two objects; and
the first object and the second object each being hands of different persons.

12. An apparatus for generating a virtual avatar, comprising:
at least one processor; and
a non-transitory memory with instructions thereon,
wherein the instructions upon execution by the processor, cause the processor to:
train a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
input a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.

13. The apparatus according to claim 12, wherein the processor is further caused to:
generate a third avatar according to the first avatar;
generate one or more third images with a different viewing angle from the second image according to the third avatar; and
adjust the third avatar to reduce a residual error between the second image and a fourth image and a residual error between the third image and a fifth image, wherein the fourth image is an image of the second object having a same viewing angle as the second image and generated by using an adjusted third avatar, and the fifth image is an image of the second object having a same viewing angle as the third image and generated by using the adjusted third avatar; and taking the adjusted third avatar as the second avatar.

14. The apparatus according to claim 13, wherein the processor is further caused to:
determine a parameter of an object code and a color correction parameter of each of the first objects, wherein one object code is used to represent one object, and an avatar of the object represented by the object code is able to be obtained through the object code; and
synthesize the third avatar with each of first avatars according to the parameter of the object code of the first objects; and synthesize a color of the third avatar with a color of the first avatar according to the color correction parameter.

15. The apparatus according to claim 13, wherein the processor is further caused to:
adjust a multilayer perceptron in the first algorithm model, wherein the multilayer perceptron in the first algorithm model is used for generating three-dimensional texture information of an avatar.

16. The apparatus according to claim 12, wherein the processor is further caused to:
generate the first avatar of the first object using the first image and the first label corresponding to the first image;
generate a sixth image of the first object according to the first avatar; and
adjust the first avatar to reduce a residual error between the sixth image regenerated on the basis of an adjusted first avatar and the first image.

17. The apparatus according to claim 16, wherein the processor is further caused to:
determine a geometry of the first object according to a sampling point in the first image, and an object pose and an object mesh of the first object in the first image;
determine three-dimensional texture information of the first object according to an object code of the first object in the first image, the sampling point and the object mesh of the first object in the first image;
determine shadow information of the first object according to the sampling point in the first image, the object mesh of the first object in the first image, and the object pose of the first object in the first image; and
obtain the first avatar of the first object according to the geometry of the first object, the three-dimensional texture information of the first object and a shadow value of the first avatar,
wherein the first label comprises: the object pose and the object mesh of the first object in the first image.

18. The apparatus according to claim 17, wherein the processor is further caused to:
create an object texture domain of the first object; and determine the texture value of the sampling point on the basis of the object texture domain and according to the object code of the first object, the sampling point and the object mesh of the first object in the first image, to obtain the three-dimensional texture information of the first avatar.

19. The apparatus according to claim 12, wherein the processor is further caused to one or more selected from the following:
adjust a geometry of the second avatar in response to changing the object mesh and/or a geometry parameter of the second avatar;
acquire object codes of at least two objects, performing interpolation calculation using the at least two object codes, and generate a fourth avatar using the object codes subjected to interpolation calculation, wherein an appearance of the fourth avatar is an interpolation calculation result of the avatars of the at least two objects; and
the first object and the second object each being hands of different persons.

20. A non-transitory computer-readable storage medium storing instructions that cause at least a processor to:
train a first algorithm model using a first image of a first object and a first label corresponding to the first image such that the first algorithm model generates a first avatar of the first object, wherein a number of first objects is at least two, a number of first images is at least two, and one first avatar is an avatar of one first object; and
input a single second image of a second object and a second label corresponding to the second image into the first algorithm model trained such that the first algorithm model generates a second avatar of the second object according to the first avatar,
wherein a number of the second object is one, the second avatar is an avatar of the second object, the second object is a homogeneous object which is different from the first object, and the first avatar and the second avatar are implicit avatars.
